(19) United States
(12) Patent Application Publication
(10) Pub. No.: US 2016/0288146 A1
(43) Pub. Date: Oct. 6, 2016

(54) AN AUTOMATIC APPARATUS FOR PNEUMATIC PAINTING

(71) Applicant: EUROSIDER S.A.S. di Milli Ottavio & C., Grosseto (IT)

(72) Inventor: Ottavio MILLI, Grosseto (IT)

(73) Assignee: Eurosider S.A.S, Grosseto (IT)

(21) Appl. No.: 15/037,615

(22) PCT Filed: Nov. 19, 2014
(86) PCT No.: PCT/IB2014/002492

§ 371 Date: May 18, 2016

(30) Foreign Application Priority Data
Nov. 25, 2013 (IT) FI2013A000286

(51) Int. Cl. B05B 7/16; B05B 5/03; B05B 5/04; B05B 7/08; B05B 7/24; B05B 3/10; B05B 12/08; B05B 15/04; B05D 1/02; B01D 53/22; B01D 69/08; B01D 63/02; B01D 65/00; C01B 21/04; B05B 5/00

(52) U.S. Cl. CPC B05B 7/1613; B05B 5/001; B05B 5/03; B05B 5/0407; B05B 7/0815; B05B 7/2491; B05B 3/1014; B05B 12/087; B05B 15/0431; B05D 1/02; B01D 53/228; B01D 69/08; B01D 63/02; B01D 65/00; C01B 21/0444; B01D 2313/18; B01D 2317/02; B01D 2313/22

(57) ABSTRACT

An automatic air spray painting apparatus, includes a painting device (2), a module (17), supplied by a source (1) of pressurized ambient air for continuous production of a flow of carrier fluid constituted by high-purity (98%-99.9%) nitrogen, elements (19, 24, 25) for regulating the pressure of the flow of nitrogen, and adjustable elements (18, 9, 26) for heat conditioning of the flow of nitrogen.

### SECTOR OF THE INVENTION

The present disclosure relates to an apparatus for rotary-bell air spray painting, of the type used in plants for industrial painting.

In particular, the apparatus finds application in automatic painting systems that make use of apparatuses for continuous production of a carrier fluid obtained starting from compressed ambient air.

### PRIOR ART

It is known that in automatic painting systems, robotized arms are used that carry at the end an operating head for air spray painting that may be constituted by an air gun or by a rotary-bell device of the conventional or electrostatic type. In the first case, the system sends to the gun a flow of carrier fluid, which is to atomize the paint, and a second flow of carrier fluid, which is to form the paint fan or shaping air.

In the case of rotary bells, the system sends to the painting head a central flow of paint, a first flow of fluid under pressure that serves for rotation of the bell, and a second, peripheral, flow of carrier fluid under pressure that is to atomize and entrain the paint, and thus form the paint cone or shaping air.

Currently, in automatic industrial systems for atomization of paint, normally used as thrust carrier fluid is compressed air at a pressure generally not lower than 3-6 barG.

However, robotized automatic painting systems of a known type do not prove satisfactory for control of the paint cone or fan (shaping air) and suffer from the phenomenon of overspray, i.e., the loss of paint that does not reach the substrate to be painted but is dispersed in the painting environment.

A further drawback is the relatively high pressure that must be used for compressing the carrier fluid and obtaining a sufficiently high speed of impact of the atomized paint on the substrate to be painted.

### Purpose of the Invention

A first purpose of the present invention is hence an apparatus that will not present the aforesaid drawbacks of the known systems described, and will be able to increase the density of the shaping air in order to atomize the paint more effectively and at the same time reduce the pressure of the carrier fluid necessary for atomization.

### SUMMARY OF THE INVENTION

The above and further purposes are achieved by an apparatus according to one or more of the annexed claims.

A first advantage of the invention lies in the fact that the density of the atomized paint is greater than that obtained with systems of a known type and enables a considerable improvement of the coating of the substrate in terms of covering power, painting speed, and grip of the layer of paint deposited on the substrate.

A further advantage is that the system enables increase of the efficiency of transfer of the paint on the articles to be painted and markedly reduces overspray as a result of the reduction of the pressure and the higher density.

A further advantage is that the system enables, as a result of the higher density of the carrier, approach of the bells to the articles to be painted in order to obtain a better uniformity of the thicknesses and reduce also in this case the overspray effect and reduce, in the case of electrostatic rotary bells, the electrostatic power.

A further advantage is to reduce the number of passes of application and obtain the same thicknesses with a single coat, markedly reducing the cycle times, for example in robotized systems for painting car bodies and components or other similar articles.

### LIST OF THE DRAWINGS

The above and further advantages will be better understood by any person skilled in the branch from the ensuing description and the annexed drawings, which are provided purely by way of non-limiting example and in which:

FIG. 1 is a schematic illustration of an apparatus according to the invention;

FIG. 2 shows a view from above of the apparatus of FIG. 1;

FIG. 3 shows an automatic painting arm carrying an atomizer device;

FIG. 4 shows an automatic painting arm carrying a rotary-bell device; and

FIG. 5 shows an example of rotary-bell air painting device of a known type.

### DETAILED DESCRIPTION

With reference to the attached drawings an automatic air spray painting apparatus is described, of the type comprising a module 17 for producing a flow of carrier fluid under pressure, which is obtained starting from a supply 1 of compressed air and is to be delivered to at least one automatic painting device 2 equipped with a robotized arm 3 provided with an operating head 30 for air spray painting with an outlet 4 for paint, and at least one second outlet 5 for a pressurized flow of a fluid, set around said first outlet for formation of a paint cone or fan.

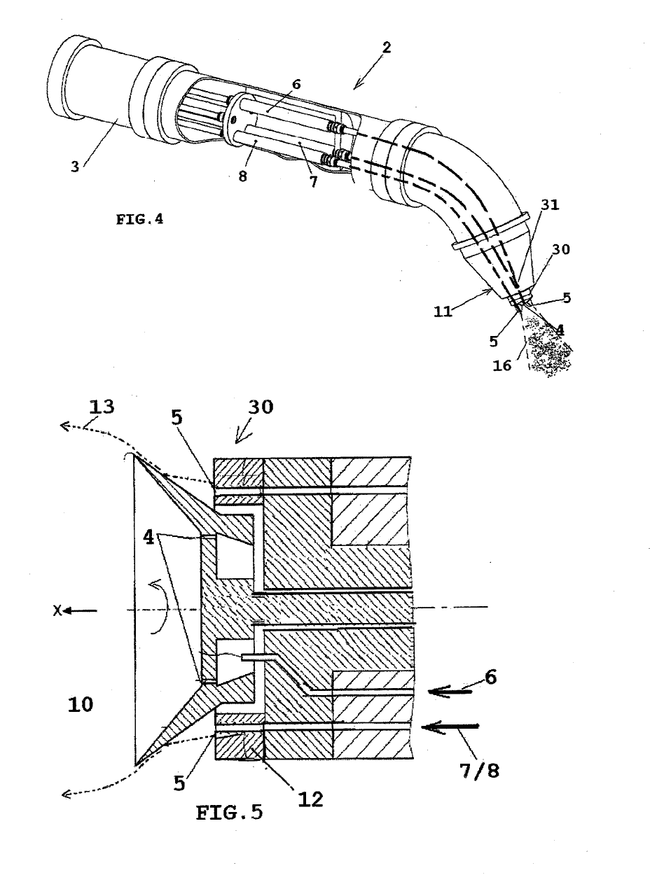

The device 2, represented schematically in FIGS. 3 and 4, further comprises a duct 6 for supply of a flow of paint from a paint source to the outlet 4 and a duct 7 for supply of a pressurized flow of carrier fluid that is to atomize said flow of paint. The duct 7 may coincide or not with a further duct 8 for supply of a pressurized flow of carrier fluid to be delivered to the second outlets 5.

According to the invention, the module 17 is a hollow-fibre separation module supplied by the source 1 of pressurized ambient air for continuous production of a flow of carrier fluid constituted by high-purity nitrogen, preferably at 98% to 99.9%, and comprises both means 19, 25, 26 for regulating the pressure of the nitrogen produced at a pressure comprised between 0.5 and 4 bar, preferably between 0.5 and 1.5 bar, and means 18, 9 for heat conditioning of the flow of nitrogen at a temperature that can be regulated between 8° C. and 80° C., preferably between 8° C. and 22° C.

According to a further advantageous characteristic of the invention, the apparatus moreover comprises an adjustable heated tube 29 for thermal stabilization of the flow of nitrogen leaving the separation module 17.

In operation, the module 17 is connected to a control unit 50 that manages automatic operation of the apparatus and in particular governs the movements and cycles of operation of the device 2 and enables setting of both the parameters for producing the carrier fluid (purity, temperature, pressure) and the painting parameters (speed, displacements, number of passes).

Advantageously, with this solution the density of the atomized paint is considerably increased, thanks to the higher specific weight of nitrogen, which can be sent to the duct 7 at a relatively low pressure and at a temperature adjusted on the basis of the ambient painting conditions and the type of substrate to be painted.

In a preferred embodiment, the apparatus comprises an ionization unit 28, in itself known, capable of ionizing the flow of nitrogen with charges of positive or negative sign, or in the neutral plasma state.

Illustrated in FIG. 3 is a painting device in which the operating head is a rotary-bell device (of a type in itself known according to the representation of FIG. 5) comprising a rotary bell 10 that turns thanks to a pneumatic motor driven by a flow of fluid under pressure that is supplied by a duct 14 and may coincide or not with the fluid used as carrier fluid.

The bell 10 is set at one end 11 of the arm 3 and is provided at the centre with the paint outlet 4 communicating with the paint-supply duct 6 for carrying out a centrifugal dispersion of the flow of paint towards the edges of the bell. The head 30 moreover comprises a ring 12 set upstream of the bell and provided with outlets 5 for nitrogen, which are directed towards the bell in the painting direction X and communicate with said duct 7 for supplying the flow of nitrogen for atomization, which in this case also performs the function of forming a paint cone 13.

Illustrated in FIG. 4 is a painting device in which the above operating head is an air spray painting gun comprising a paint outlet 4, which is set at the end 11 of the arm 3 and communicates with the paint-supply duct 6 and the duct 7 for supplying the flow of nitrogen for atomization. In this case, the flow of paint and the flow of nitrogen for atomization converge, in a way in itself known and not described further, in a point 31 upstream of the outlet 4.

The head 30 moreover has at least two side nitrogen outlets 5, which communicate with the duct 8 for supplying the flow of nitrogen for formation of a paint fan 16.

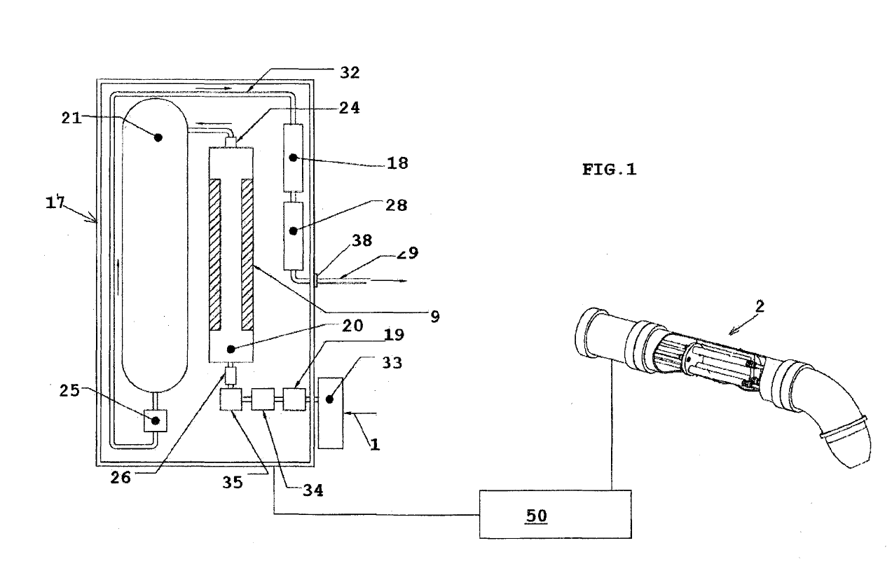

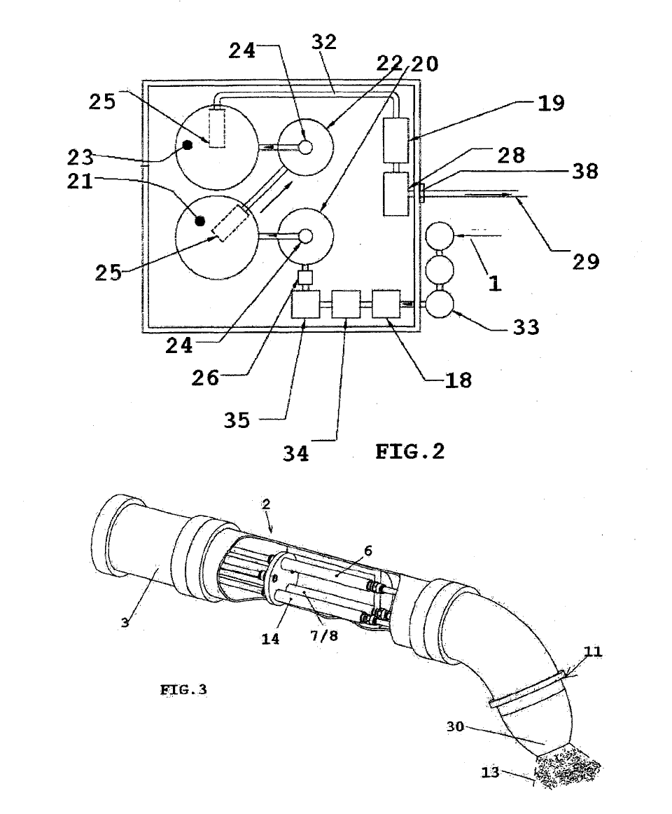

With reference to FIGS. 1 and 2, a preferred embodiment of a module 17 for producing the carrier fluid is described, which envisages a first hollow-fibre separation membrane 20, which is supplied by the compressed-air source 1 provided with filters 33 and communicates at outlet with a first reservoir 21 for storing nitrogen (or nitrogen-rich modified air), which in turn communicates at outlet with a second hollow-fibre separation membrane 22 that sends the high-purity nitrogen into a second reservoir 23 for storing pressurized nitrogen.

In the example described, the heat-conditioning means comprise a cooling and/or heating assembly 18, which receives the flow of nitrogen leaving the reservoir 23, preferably through a thermally insulated tube 32, and is able to stabilize the temperature of the flow of nitrogen at a value adjustable between 8° C. and 80° C.

The heat-conditioning means may moreover comprise a heater 26 set at inlet to the first membrane 20, capable of heating the air to a temperature of between 10° C. and 60° C., and an external heater 9 for heating at least the membrane 20, which is also active in a temperature range of between 10° C. and 60° C.

Once again in the preferred example illustrated, the means for regulating the pressure are a pressure regulator 19 set downstream of the compressed-air source 1, a flow-regulator valve 24 set immediately downstream of one or both of the membranes 20, 22, and a back-pressure-regulating valve or back-pressure regulator (BPR) 25 set immediately downstream of one or both of the reservoirs 21, 23.

Preferably, the compressed air arriving from the source 1, before entering the membrane 20, traverses in succession the pressure regulator 26, a solenoid valve 34, a progressive actuator 35 for partialization of the flow, and the heater 26. Advantageously, with this solution sending of the compressed air into the membrane occurs also at start of operations in optimal conditions that can be regulated thanks to control of the pressure and of the temperature and to the progressive actuator 35, which prevents immediate introduction of the entire flow of compressed air into the membrane.

In some examples of application, it has been found that with the parameters appearing below excellent painting results are obtained.

### EXAMPLE 1

Painting of plastic material in an environment at a temperature of 20° C.
purity 99.5%
pressure 2 bar
temperature 18° C.
positive ionization

### EXAMPLE 2

Metal substrate
purity 99%
pressure 1.8 bar
temperature 18° C.
negative ionization.

The present invention has been described according to preferred embodiments, but equivalent variants may be conceived, without thereby departing from the sphere of protection of the invention.

1-16. (canceled)

17. An automatic air spray painting apparatus, comprising:
at least one painting device (2) equipped with a robotized arm (3) provided with a painting operating head (30), including:
a first outlet (4) for paint; and
at least one second outlet (5) for a pressurized flow of a fluid for the formation of a paint cone or fan;
a duct (6) for supplying a flow of paint from a paint source to said paint outlet (4);
a duct (7) for supplying a pressurized flow of carrier fluid that is to atomize said flow of paint;
a duct (8) for supplying a pressurized flow of carrier fluid to said second outlets for forming the paint cone or fan;
a separation module (17), supplied by a source (1) of pressurized ambient air for the continuous production of a flow of carrier fluid constituted by high-purity (98%-99.9%) nitrogen directed to said paint outlet (4)and to said at least one second outlet (5);
means (19, 24, 25) for regulating the pressure of the flow of nitrogen for atomization; and
adjustable means (18, 9, 26) for heat conditioning of the flow of nitrogen for atomization.

18. The apparatus according to claim 17, wherein said means (19, 24, 25) for regulating the pressure are provided for keeping the flow of nitrogen at a pressure comprised between 0.5 and 4 bar, preferably between 0.5 and 1.5 bar.

19. The apparatus according to claim 17, wherein said heat-conditioning means (18, 9, 26) are provided for keeping the flow of nitrogen at a temperature adjustable between 8° C. and 80° C., preferably between 8° C. and 22° C.

20. The apparatus according to claim 17, wherein said operating head is a rotary-bell air painting device, comprising:
a rotary bell (10) set at one end (11) of the arm (3) and provided with said paint outlet (4) communicating with said paint-supply duct (6) for carrying out a centrifugal dispersion of said flow of paint towards the edges of the bell (10); and
a ring (12) set upstream of the bell and provided with said second outlets (5) for the nitrogen, which are directed towards said bell (10) in a painting direction (X) and communicate with said ducts (7) for supply of nitrogen for atomization and for formation of a paint cone (13).

21. The apparatus according to claim 17, wherein said operating head is an air paint spray gun comprising:
a paint outlet (4) set at the end (11) of the arm (3), communicating with said paint-supply duct (6) and with said duct (7) for supplying the flow of nitrogen for atomization; and
at least two second outlets (5) for the nitrogen communicating with said duct (8) for supplying the flow of nitrogen, which are set alongside said first outlet for formation of a paint fan (16).

22. The apparatus according to claim 17, wherein said separation module (17) comprises at least one first hollow-fibre separation membrane (20), supplied by said compressed-air source (1) and communicating at outlet with a first reservoir (21) of nitrogen, which in turn communicates at outlet at least with said duct (7) for supply of a flow of atomization carrier fluid.

23. The apparatus according to claim 22, comprising a second hollow-fibre separation membrane (22) communicating at inlet with said first reservoir (21) and at outlet with a second reservoir (23) of pressurized nitrogen.

24. The apparatus according to claim 22, wherein said heat-conditioning means comprise an assembly (18) for cooling/heating the flow of nitrogen leaving the separation module (17).

25. The apparatus according to claim 22, wherein said means for regulating the pressure comprise a pressure regulator (19) set downstream of the compressed-air source (1).

26. The apparatus according to claim 22, comprising a flow-regulator valve (24) immediately downstream at least of said first membrane (20) and a back-pressure-regulator (BPR) valve (25) immediately downstream at least of said first reservoir (21).

27. The apparatus according to claim 22, wherein said heat-conditioning means comprise a heater (26) for heating the flow of air at inlet to said first membrane (20).

28. The apparatus according to claim 22, wherein said heat-conditioning means comprise an external heater (9) for heating at least one membrane (20, 22).

29. The apparatus according to claim 17, comprising an adjustable heated tube (29) for thermal stabilization of the flow of nitrogen leaving the separation module (17).

30. The apparatus according to claim 17, comprising an assembly (28) for ionizing the flow of nitrogen leaving the separation module (17), which can be regulated for producing positive ions, negative ions, or plasma.

31. A module for the continuous production of a flow of high-purity (98%-99.9%) nitrogen starting from a source (1) of pressurized ambient air for use as carrier fluid in air paint-spray plants,
said module comprising:
a first hollow-fibre separation membrane (20), supplied by said compressed-air source (1) and communicating at outlet with a first reservoir (21) of nitrogen;
a second hollow-fibre separation membrane (22) communicating at inlet with said first reservoir (21) and at outlet with a second reservoir (23) of pressurized nitrogen, which in turn communicates with an outlet (38) of pressurized nitrogen;
means (19, 24, 25) for regulating the pressure of the flow of nitrogen at outlet (38) to a pressure comprised between 0.5 and 4 bar, preferably between 0.5 and 1.5 bar;
adjustable means (18, 9, 26) for heat conditioning of the flow of nitrogen at outlet (38) at a temperature adjustable between 8° C. and 80° C., preferably between 8° C. and 22° C.

32. A method for air spray painting by means of an automatic air spray painting apparatus, comprising:
at least one painting device (2) equipped with a robotized arm (3) provided with a paint-spray operating head (30) including:
a first outlet (4) for paint; and
at least one second outlet (5) for a pressurized flow of a fluid for formation of a paint cone or fan;
a duct (6) for supply of a flow of paint from a paint source to said paint outlet (4);
a duct (7) for supply of a pressurized flow of carrier fluid that is to atomize said flow of paint; and
a duct (8) for supply of a pressurized flow of carrier fluid to said second outlets for forming the paint cone or fan,
said method comprising the following steps:
supplying said duct (7) and said duct (8) for supply of a pressurized flow of carrier fluid to said second outlets for forming the paint cone or fan, with a flow of carrier fluid constituted by high-purity (98%-99.9%) nitrogen obtained continuously by means of a separation module (17) supplied by a source (1) of pressurized ambient air;
regulating the pressure of the flow of nitrogen for atomization at an adjustable pressure comprised between 0.5 and 4 bar, preferably between 0.5 and 1.5 bar; and
thermally conditioning the flow of nitrogen for atomization at a temperature adjustable between 8° C. and 80° C., preferably 8° C. to 22° C.

33. The apparatus according to claim 23, wherein said heat-conditioning means comprise an assembly (18) for cooling/heating the flow of nitrogen leaving the separation module (17).

34. The apparatus according to claim 23, wherein said means for regulating the pressure comprise a pressure regulator (19) set downstream of the compressed-air source (1).

35. The apparatus according to claim 23, comprising a flow-regulator valve (24) immediately downstream at least of said first membrane (20) and a back-pressure-regulator (BPR) valve (25) immediately downstream at least of said first reservoir (21).
